(19) United States
(12) Patent Application Publication
(10) Pub. No.: US 2025/0304402 A1
(43) Pub. Date: Oct. 2, 2025

(54) SHEET PROCESSING APPARATUS AND IMAGE FORMING SYSTEM

(71) Applicant: FUJIFILM Business Innovation Corp., Tokyo (JP)

(72) Inventors: Masashi MATSUMOTO, Kanagawa (JP); Taichi FUCHU, Kanagawa (JP)

(73) Assignee: FUJIFILM Business Innovation Corp., Tokyo (JP)

(21) Appl. No.: 19/034,892

(22) Filed: Jan. 23, 2025

(30) Foreign Application Priority Data
Mar. 26, 2024 (JP) 2024-049009

(51) Int. Cl. B65H 37/06; B41J 3/44; B42C 19/02; B65H 37/04; G03G 15/00

(52) U.S. Cl. CPC B65H 37/06; B41J 3/44; B42C 19/02; B65H 37/04; G03G 15/6544; B65H 2301/4505; B65H 2301/51611; B65H 2301/51616; B65H 2801/27; G03G 2215/00827; G03G 2215/00877

(57) ABSTRACT

A sheet processing apparatus includes: a folding device that folds a sheet bundle which is formed of multiple sheets stacked on each other; and a stapleless binding device including a binding unit that binds the sheet bundle at a position of a portion near a fold line without using a staple, the fold line being formed as a result of the folding device folding the sheet bundle.

### CROSS-REFERENCE TO RELATED APPLICATIONS

This application is based on and claims priority under 35 USC 119 from Japanese Patent Application No. 2024-049009 filed Mar. 26, 2024.

### BACKGROUND

### (i) Technical Field

The present disclosure relates to a sheet processing apparatus and an image forming system.

### (ii) Related Art

Japanese Unexamined Patent Application Publication No. 2022-170714 (Paragraph 0034 and FIG. 2) discloses a sheet processing device. The sheet processing device includes a binding processor and a folding processor. The binding processor binds a sheet bundle by using staples. The folding processor folds the sheet bundle bound by the binding processor in half, for example.

Japanese Unexamined Patent Application Publication No. 2023-107564 (Paragraph 0033 and FIG. 4) discloses a postprocessing device. The postprocessing device includes a stapler and a folding mechanism. The stapler binds a sheet bundle by using staples. The folding mechanism folds the sheet bundle bound by the stapler in half.

### SUMMARY

Aspects of non-limiting embodiments of the present disclosure relate to a sheet processing apparatus and an image forming system using the same in which a sheet bundle can be bound at the position of a portion near a fold line of the sheet bundle without using staples.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a sheet processing apparatus including: a folding device that folds a sheet bundle which is formed of multiple sheets stacked on each other; and a stapleless binding device including a binding unit that binds the sheet bundle at a position of a portion near a fold line without using a staple, the fold line being formed as a result of the folding device folding the sheet bundle.

### BRIEF DESCRIPTION OF THE DRAWINGS

Exemplary embodiments of the present disclosure will be described in detail based on the following figures, wherein:

FIG. 1 is a schematic view illustrating an image forming system according to first and second exemplary embodiments;

FIG. 2 is a schematic view illustrating the major part of a sheet processing apparatus of the image forming system;

FIG. 3 is a schematic view illustrating part of the sheet processing apparatus, such as a folding device and a stapleless binding device, as viewed from above;

FIG. 4 is an enlarged schematic view illustrating part of the folding device and the stapleless binding device;

FIG. 5 is a schematic front view illustrating the state of the stapleless binding device which is not performing binding processing;

FIG. 6A is a schematic side view illustrating the state of a pressure-binding unit of the stapleless binding device which is not performing a pressure-binding operation;

FIG. 6B is a schematic side view illustrating the state of the pressure-binding unit of the stapleless binding device which is performing a pressure-binding operation;

FIG. 7A is a perspective view illustrating first and second tooth trains of the pressure-binding unit;

FIG. 7B is a schematic front view illustrating the state of the first and second tooth trains which are not performing binding processing;

FIG. 7C is a schematic front view illustrating the state of the first and second tooth trains which are performing binding processing;

FIG. 8 is a block diagram illustrating the configuration of a control system of the image forming system;

FIG. 9 is a flowchart illustrating a control operation of stapleless centerfold binding processing;

FIG. 10A is a schematic view illustrating a press-bending operation of the folding device;

FIG. 10B is a schematic view illustrating a folding-transport operation of a folding-transporter;

FIG. 10C is a schematic view illustrating a folded sheet bundle which is being loaded to a loader;

FIG. 11A is a perspective view illustrating a sheet bundle which has not been folded;

FIG. 11B is a schematic view illustrating a folded sheet bundle;

FIG. 11C is a schematic view illustrating a sheet bundle which is bound without a staple;

FIG. 12A illustrates an example of the relationship between the number of sheets and the number of portions to be bound without staples;

FIG. 12B illustrates examples of portions of a sheet bundle to be bound without staples;

FIG. 13 is a flowchart illustrating a control operation of stapleless centerfold binding processing executed by a sheet processing apparatus according to the second exemplary embodiment;

FIG. 14A is a schematic view illustrating the storage state of sheet bundles subjected to stapleless centerfold binding processing;

FIG. 14B is a schematic view illustrating a sheet bundle subjected to staple centerfold binding processing;

FIG. 14C is a schematic view illustrating the storage state of sheet bundles subjected to staple centerfold binding processing;

FIG. 15 is a schematic view illustrating a sheet processing apparatus according to a third exemplary embodiment; and

FIG. 16 is a block diagram illustrating the configuration of a control system of the sheet processing apparatus shown in FIG. 15.

### DETAILED DESCRIPTION

Exemplary embodiments of the disclosure will be described below.

### First Exemplary Embodiment

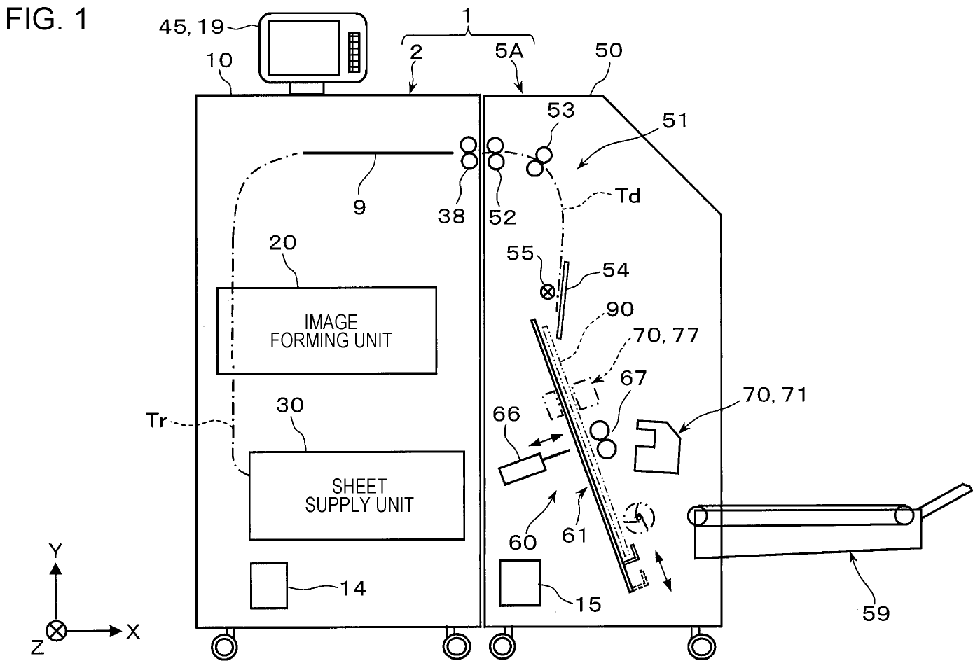

FIG. 1 is a schematic view illustrating an image forming system 1 including a sheet processing apparatus 5A according to a first exemplary embodiment.

In the specification and the drawings, substantially the same elements are designated by like reference numeral and an explanation thereof will not be repeatedly given in the specification.

As illustrated in FIG. 1, the image forming system 1 includes an image forming apparatus 2 and the sheet processing apparatus 5A.

The image forming apparatus 2 is a device that forms an image on a sheet 9.

The sheet processing apparatus 5A is a device that performs binding processing for a sheet bundle 90, which is formed by stacking multiple sheets 9 output from the image forming apparatus 2. The sheet processing apparatus 5A of the first exemplary embodiment is a separate device different from the image forming apparatus 2 and is used by connecting it to the image forming apparatus 2.

### (Image Forming Apparatus)

As shown in FIG. 1, the image forming apparatus 2 includes an image forming unit 20, a sheet supply unit 30, and a sheet transport path Tr, for example, within a housing 10.

The image forming apparatus 2 includes some devices, such as an operation display 45, disposed outside the housing 10.

The housing 10 is a structure having a predetermined internal space and a predetermined external shape.

The image forming unit 20 forms a desired image on a sheet 9.

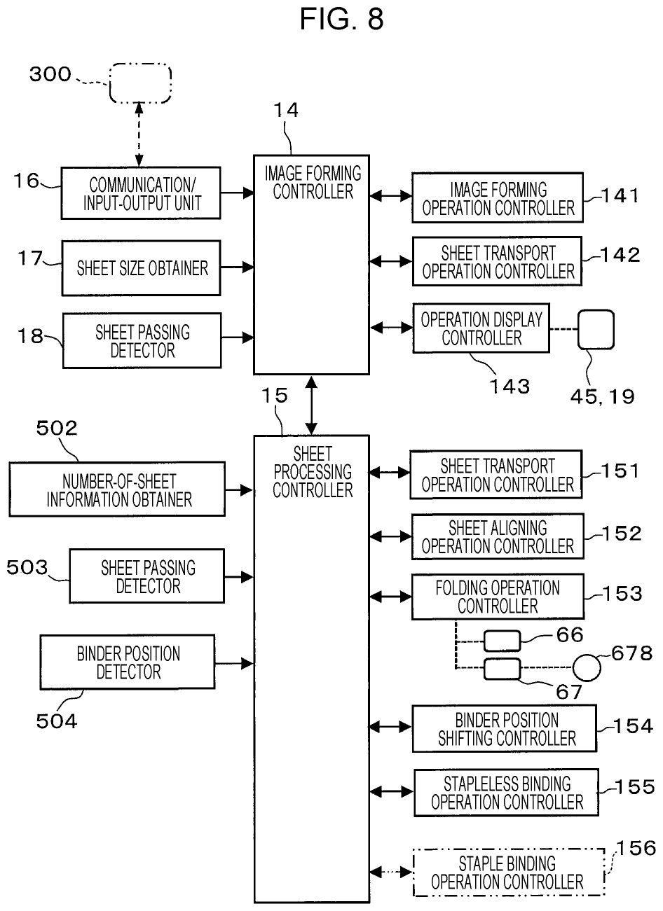

As the image forming unit 20, any type of device may be used if it can form an image based on desired image information on a sheet 9. The image forming method and the image format used in the image forming unit 20 are not restricted to a particular type. Typically, image information is input from an external connection device 300 (see FIG. 8), such as an information terminal or a storage medium.

As the image forming method, an electrophotographic system or an inkjet method, for example, is applicable. An image to be formed may be a monochromatic (black and white, for example) image or may be a multicolor image.

If the image forming unit 20 based on the electrophotographic system is used, the intermediate transfer method or the direct transfer method is employed. In the intermediate transfer method, an image, which is not yet fixed (such an image will be called an unfixed image), is transferred from a photoconductor to a sheet via an intermediate transfer body. In the direct transfer method, an unfixed image is directly transferred from a photoconductor to a sheet.

The sheet supply unit 30 supplies a sheet 9 to the image forming unit 20.

The sheet supply unit 30 includes one or multiple containers and one or multiple feeders, neither of which is shown.

The container is a structure, such as a tray or a cassette, in which multiple sheets 9 are stacked and stored therein. The feeder is a device that feeds sheets 9 from the container one by one.

The sheet transport path Tr is a path for transporting a sheet 9 via a predetermined position inside the housing 10.

The sheet transport path Tr includes a portion (sheet feeding path) that transports a sheet 9 from the sheet supply unit 30 to a part of the image forming unit 20 that forms an image on the sheet 9.

The sheet transport path Tr also includes a portion (sheet output path) that transports a sheet 9 from the image forming unit 20 to a transport exit, which is not shown. The transport exit is an opening through which a sheet 9 is output from the housing 10 to the sheet processing apparatus 5A.

The sheet transport path Tr also includes a portion (sheet eject path) that transports a sheet 9 from the image forming unit 20 to a sheet eject unit. The sheet eject unit is located at a predetermined location of the housing 10 and stores a sheet 9.

In the sheet transport path Tr, a predetermined number of pairs of transport rollers and a sheet guiding member, for example, are disposed. A pair of output rollers 38 in FIG. 1 outputs a sheet 9 from the transport exit, which is not shown, to the sheet processing apparatus 5A.

As a sheet 9, a sheet on which an image can be formed in the image forming unit 20 and which can be transported by the sheet transport path Tr is used.

Sheets 9 include a sheet 9 which is to be processed by the sheet processing apparatus 5A. The processing performed by the sheet processing apparatus 5A at least includes stapleless binding processing, which will be discussed later.

The sheet 9 which requires stapleless binding processing is a sheet that can be bound by stapleless binding processing. An example of such a sheet is unprocessed plain paper.

The operation display 45 includes an operation unit and a display unit. The operation unit is used to input information required for the operation of the image forming apparatus 2 or to make a selection. The display unit displays information concerning the state and the operation of the image forming apparatus 2.

The operation display 45 is constituted by components, such as an operation panel and a liquid crystal display panel.

In response to an instruction to form an image received by the image forming apparatus 2, the image forming unit 20 forms a desired image. In the image forming apparatus 2, a sheet 9 is fed from the sheet supply unit 30 and is transported to the image forming unit 20 via the sheet feeding path of the sheet transport path Tr.

As a result, a desired image is formed on the sheet 9 when the sheet 9 is passing through the image forming unit 20.

If the image forming apparatus 2 receives a request for processing executed by the sheet processing apparatus 5A, together with an instruction to form an image, the sheet 9 having an image formed thereon is output to the sheet processing apparatus 5A. In this case, the sheet 9 is transported from the image forming unit 20 to the transport exit, which is not shown, via the sheet output path of the sheet transport path Tr.

As a result, the sheet 9 is output to the sheet processing apparatus 5A via the pair of output rollers 38.

Alternatively, in the image forming apparatus 2, a sheet having an image formed thereon may be transported from the image forming unit 20 to the sheet eject unit via the sheet eject path of the sheet transport path Tr.

Alternatively, in the image forming apparatus 2, a sheet 9 on which no image is formed by the image forming unit 20 may be output to the sheet processing apparatus 5A via the sheet transport path Tr.

### (Sheet Processing Apparatus)

As illustrated in FIG. 1, the sheet processing apparatus 5A includes a sheet guiding path 51, a folding device 60, and a binding device 70, for example, within a housing 50.

The sheet processing apparatus 5A also includes a loader 59, for example, outside the housing 50.

The housing 50 is a structure having a predetermined internal space and a predetermined external shape.

[Sheet Guiding Path]

The sheet guiding path 51 is a transport path for guiding a sheet 9 to a predetermined part inside the housing 50.

In the sheet guiding path 51, a predetermined number of pairs of transport rollers 52 and 53 and a sheet guiding member (not shown), for example, are disposed.

On the side surface of the housing 50 which faces the image forming apparatus 2, a receiver, which receives a sheet 9 output from the image forming apparatus 2, is provided. In the vicinity of the receiver, the transport rollers 52 are disposed.

In the first exemplary embodiment, the sheet guiding path 51 is formed as a transport path Td for transporting a sheet 9 guided from the receiver to the folding device 60.

In the sheet guiding path 51, a final guiding member 54 and a feeding rotator 55 are disposed.

The final guiding member 54 is the last member that guides the sheet 9 to the folding device 60. The feeding rotator 55 is rotated to feed the sheet 9 to the folding device 60 while facing the sheet guiding surface of the final guiding member 54.

### [Folding Device]

The folding device 60 folds a sheet bundle 90 which is formed of multiple sheets 9 stacked on each other.

In the first exemplary embodiment, the folding device 60 is formed as a center folder that folds a sheet bundle 90 in half.

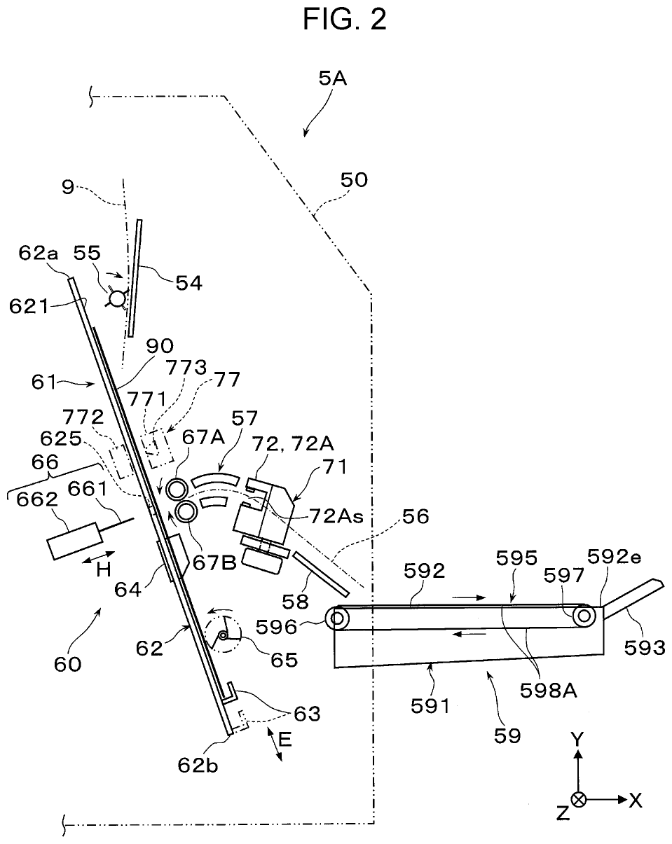

As illustrated in FIGS. 1 and 2, the folding device 60 includes a piler 61, a press-bender 66, and a folding-transporter 67, for example.

The piler 61 piles multiple sheets 9 to form a sheet bundle 90.

In the first exemplary embodiment, the piler 61 includes a piling tray 62, a side edge aligning member 64, and a push-in rotator 65, for example.

The piling tray 62 is a planar member provided with a piling surface 621 titling at a predetermined angle, as shown in FIG. 2.

The piling surface 621 of the piling tray 62 is tilted from a position on a lower side of the housing 50 toward a position near the terminating end of the sheet guiding path 51.

The piling surface 621 is formed of a substantially rectangular surface extending in the tilting direction.

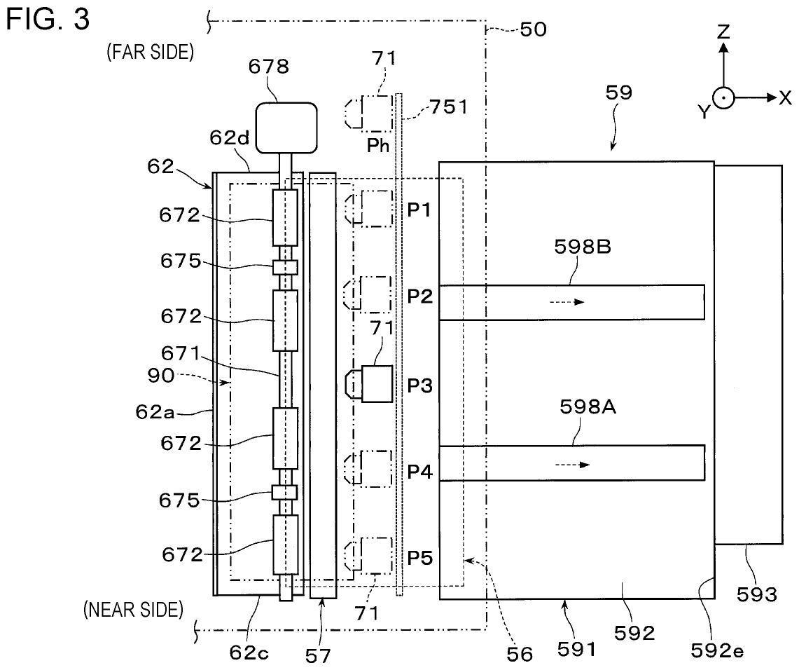

As shown in FIG. 2, the piling surface 621 has a top edge 62a and a bottom edge 62b, which form two edges in the tilting direction of the piling tray 62. As shown in FIG. 3, the piling surface 621 also has a front edge 62c and a back edge 62d, which form two edges in a direction perpendicular to the tilting direction of the piling tray 62.

As illustrated in FIG. 2, at the bottom end portion of the piling tray 62 near the bottom edge 62b, a bottom edge aligning member 63 is provided.

The bottom edge aligning member 63 is a planar member including at least a perpendicular surface portion and an opposing surface portion. The perpendicular surface portion rises perpendicularly from the piling surface 621 of the piling tray 62. The opposing surface portion bends from the top edge of the perpendicular surface portion and opposes the piling surface 621.

The bottom edge aligning member 63 is movable in the up-down direction indicated by the double-headed arrow E in FIG. 2 with respect to the piling surface 621.

The bottom edge aligning member 63 is moved in the up-down direction and is stopped at a predetermined position in accordance with the length of a sheet 9 to be piled into a sheet bundle 90 when the sheet 9 is guided to the piling tray 62. The bottom edge of a sheet 9 guided to the piling tray 62 and that of a sheet bundle 90 abut against the bottom edge aligning member 63 stopped at the predetermined position.

With this configuration, the bottom edge aligning member 63 can align the bottom edge of a sheet 9 to be piled in the piling tray 62 and that of a sheet bundle 90.

The side edge aligning member 64 is a member that aligns the side edges, that is, the front edge and the back edge, of a sheet bundle 90.

In the first exemplary embodiment, the side edge aligning member 64 is constituted by a pair of aligning members.

These aligning members are disposed to face each other near the front edge 62c and the back edge 62d.

These aligning members are moved to be close to and away from the front edge 62c and the back edge 62d of the piling tray 62.

The pair of aligning members includes a contact aligner. The contact aligner touches and aligns the front edge and the back edge of a sheet 9 to be piled in the piling tray 62 and those of a sheet bundle 90. The side edge aligning member 64 configured as described above is called a tamper, for example.

When the piler 61 is actuated, the above-described pair of aligning members of the side edge aligning member 64 are moved to be close to the front edge 62c and the back edge 62d. At this time, the contact aligner of the side edge aligning member 64 touches the front edge and the back edge of a sheet 9 and those of a sheet bundle 90.

With this configuration, the side edge aligning member 64 can align the side edges, which are the front edge and the back edge, of the sheet bundle 90.

The push-in rotator 65 is rotated by contacting a sheet 9 and a sheet bundle 90 on the piling tray 62 so as to push them toward the bottom edge aligning member 63.

The push-in rotator 65 has the following structure. Multiple elastic plates are disposed around a rotating shaft at certain intervals in the peripheral direction so as to rise from the rotating shaft. Such a push-in rotator 65 is called a rotary paddle, for example.

The push-in rotator 65 is disposed such that the peripheral portions (forward ends of the elastic plates) contact or approach the lower portion of the piling surface 621 of the piling tray 62 while the push-in rotator 65 is rotating.

The press-bender 66 presses and bends a folding portion 93 of the sheet bundle 90 formed by the piler 61.

The press-bender 66 is disposed on one side of the piling tray 62, while the folding-transporter 67 is disposed on the other side of the piling tray 62. That is, the press-bender 66 opposes the folding-transporter 67 with the piling tray 62 interposed therebetween.

In the first exemplary embodiment, the press-bender 66 includes a pushing member 661 and a shifter 662, for example, as shown in FIG. 2.

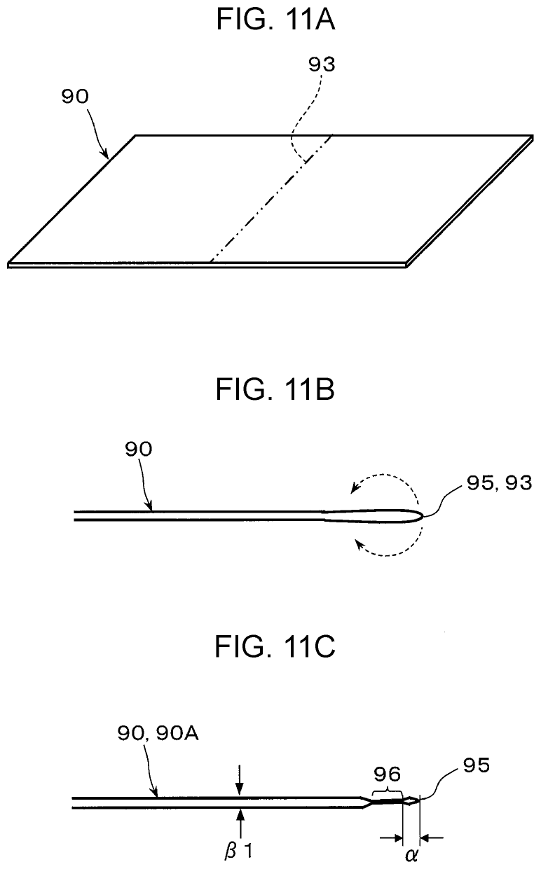

If the sheet bundle 90 is to be folded in half, the folding portion 93 corresponds to the longitudinal central portion of a sheet 9 guided to the piler 61 (see FIGS. 2 and 11A).

The pushing member 661 contacts and presses the folding portion 93 of the sheet bundle 90 so as to force the bundle sheet 90 to be folded.

The pushing member 661 is formed of a planar member and is called a folder knife, for example.

The shifter 662 shifts the pushing member 661 while holding it.

The shifter 662 shifts the pushing member 661 so that the pushing member 661 becomes close to and away from the folding-transporter 67.

The shifter 662 also moves the pushing member 661 in the direction indicated by the double-headed arrow H in FIG. 2 using a drive force of a drive motor, which is not shown.

The shifter 662 shifts the pushing member 661 to a pushing position projecting from the piling surface 621 via a through-portion 625 of the piling tray 62. The shifter 662 also shifts the pushing member 661 to a waiting position which does not project from the piling surface 621.

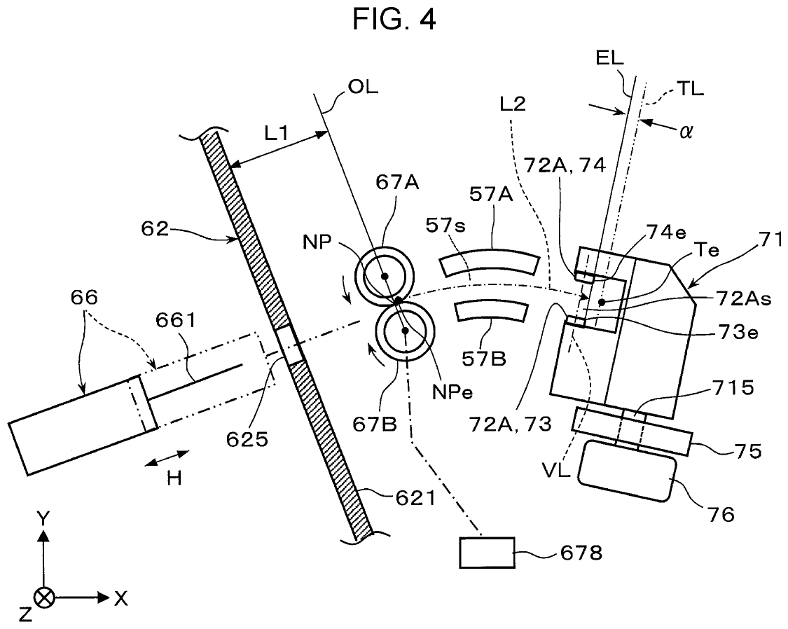

The through-portion 625 is an opening provided at a position at which folding processing is performed in the piling tray 62, as shown in FIGS. 2 and 4. The through-portion 625 faces the folding portion 93 (see FIG. 2) of the sheet bundle 90 placed on the piling tray 62.

At the time of performing folding processing, the pushing member 661 of the press-bender 66 is shifted to the pushing position. At this time, the forward end of the pushing member 661 contacts the folding portion 93 of the sheet bundle 90 placed on the piling surface 621 of the piling tray 62 and pushes the folding portion 93 by a predetermined amount.

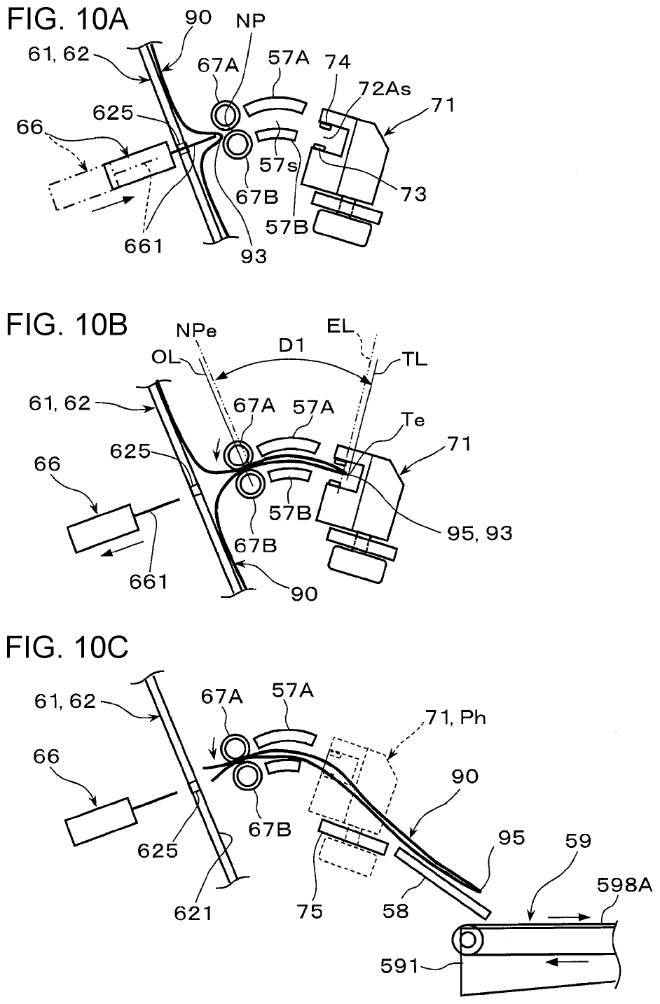

With this operation, the press-bender 66 can press and bend the folding portion 93 of the sheet bundle 90 (see FIG. 10A).

The folding-transporter 67 transports the sheet bundle 90 in such a manner as to pinch and fold the sheet bundle 90 having the folding portion 93 pressed and bent by the press-bender 66 as the leading end.

As described above, the folding-transporter 67 opposes the press-bender 66 with the piling tray 62 interposed therebetween. In other words, the folding-transporter 67 is disposed on the same side of the piling tray 62 as the piling surface 621.

In the first exemplary embodiment, the folding-transporter 67 is constituted by a pair of folding rollers 67A and 67B.

The folding rollers 67A and 67B are rotated in the directions indicated by the arrows in FIGS. 2 and 4 while contacting each other.

As illustrated in FIG. 3, the folding roller 67A is formed such that multiple roller bodies 672 are disposed at predetermined intervals on a rotating shaft 671. Bearings 675 are provided to support the rotating shaft 671.

As in the folding roller 67A, the folding roller 67B is constituted by a rotating shaft and multiple roller bodies, none of which are shown.

As shown in FIG. 4, one or both of the folding rollers 67A and 67B are driven to rotate in the directions indicated by the arrows in FIG. 4 by the rotational force from a rotation driver 678.

The folding rollers 67A and 67B are disposed such that a straight line OL connecting the centers of rotation of the folding rollers 67A and 67B becomes substantially parallel with the piling surface 621 of the piling tray 62.

The folding rollers 67A and 67B are also disposed such that the straight line OL is separated from the piling surface 621 of the piling tray 62 by a predetermined distance L1.

The straight line OL substantially intersects with the rotation-direction center of a contact portion NP where the folding rollers 67A and 67B contact each other.

At the time of folding processing, the folding rollers 67A and 67B of the folding-transporter 67 are driven to rotate.

The folding rollers 67A and 67B then transport the sheet bundle 90 by inserting the folding portion 93 press-bent by the press-bender 66 into the contact portion NP as the leading end (see FIG. 10B).

### [Loader]

The loader 59 loads the sheet bundle 90 which has passed through the folding-transporter 67. The sheet bundle 90 is supplied to the loader 59 in a state in which a fold line 95 of the sheet bundle 90 is the leading end.

The loader 59 is provided on the other side of the housing 50 which is separated from the image forming apparatus 2. The loader 59 is disposed on the lower portion on this side of the housing 50 so as to protrude from this side of the housing 50.

In the first exemplary embodiment, the loader 59 includes a loading tray 591 and a transport belt device 595.

The loading tray 591 is a structure having a storage surface 592. Sheet bundles 90 are stored obliquely on the storage surface 592. The loading tray 591 includes a sheet bundle stoppage portion 593 having a stopping slope raising from a terminating end 592e of the storage surface 592.

The transport belt device 595 includes transport belts 598A and 598B wound on multiple rollers 596 and 597 and rotates in the direction indicated by the arrows in FIG. 2.

The transport belt device 595 transports a sheet bundle 90 toward the terminating end 592e of the storage surface 592 by using the transport belts 598A and 598B.

The running top surfaces of the transport belts 598A and 598B are exposed on the storage surface 592.

The sheet processing apparatus 5A has a passage 56 indicated by the dotted line in FIG. 3 that allows a sheet bundle 90 folded by the folding-transporter 67 to pass therethrough.

The passage 56 is a space area (passage space) that allows a sheet bundle 90 folded by the folding-transporter 67 to pass therethrough to the loader 59.

The passage 56 is not limited to a space area formed by disposing a transport guiding member or a passage forming member. That is, the arrangement or the shapes of some of the peripheral components or devices located between the folding-transporter 67 and the loader 59 may be adjusted to form the passage 56 as a space area. [Binding Device (Stapleless Binding Device)]

As illustrated in FIGS. 1 and 2, for example, the binding device 70 includes a stapleless binder 71 as an example of a stapleless binding device.

The stapleless binder 71 binds a bundle sheet 90 at the position of a portion near the fold line 95 folded by the folding device 60 without using staples.

The portion near the fold line 95 is a portion located inward from the fold line 95 by a predetermined dimension α, as illustrated in FIG. 11C. The predetermined dimension a is selected from a range of 1 to 10 mm, for example.

As illustrated in FIGS. 4 through 7A, the stapleless binder 71 includes a binding unit 72 that binds a sheet bundle 90 at the position of the portion near the fold line 95 without using staples.

In the first exemplary embodiment, the binding unit 72 includes a pressure-binding unit 72A that binds the portion near the fold line 95 by applying pressure thereto.

The pressure-binding unit 72A includes a first tooth train 73 and a second tooth train 74.

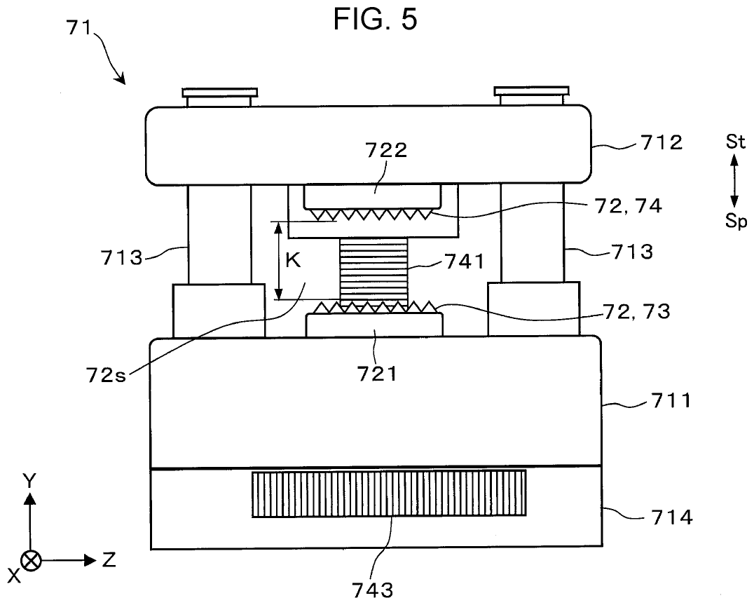

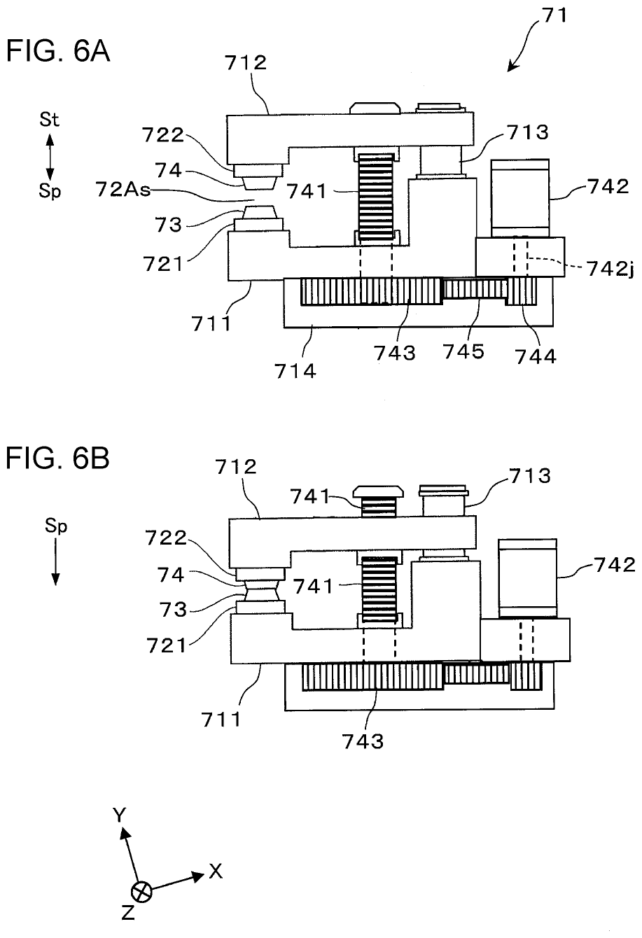

The position of the first tooth train 73 is fixed, as shown in FIGS. 5 through 6B.

The second tooth train 74 advances and retreats to engage with the first tooth train 73 so as to press part of a sheet bundle 90 against the first tooth train 73.

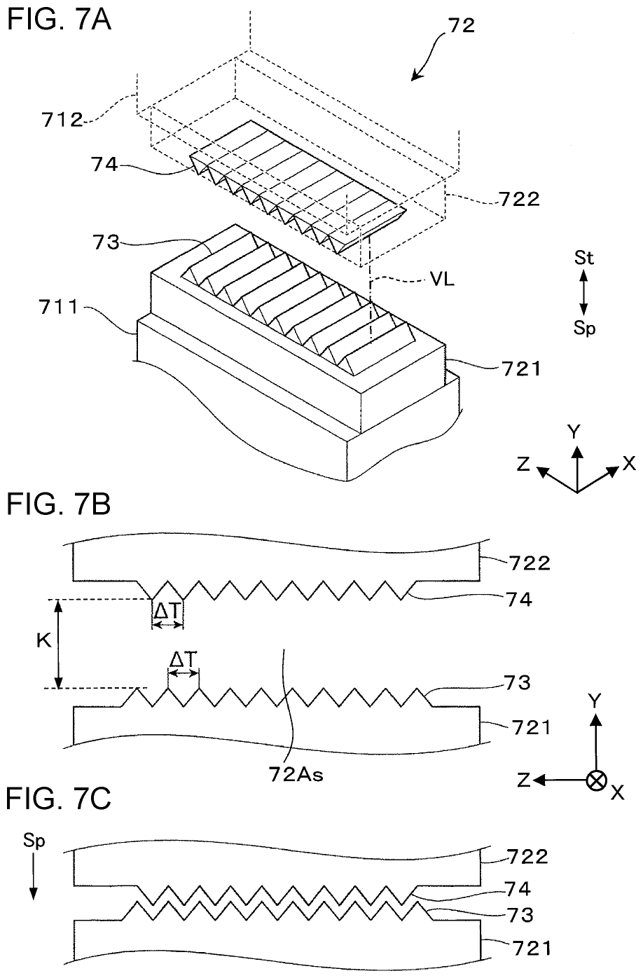

As shown in FIG. 7A, the first tooth train 73 has a predetermined number of bumps (teeth) on the surface of a base 721 so as to face the second tooth train 74.

As also shown in FIG. 7A, the second tooth train 74 has a predetermined number of bumps (teeth) on the surface of a base 722 so as to face the first tooth train 73.

The bumps of the first and second tooth trains 73 and 74 each have predetermined dimensions (length, width, and height).

The bumps each have a tapered shape in cross section that becomes narrower toward the top edge and are continuously provided at regular intervals AT (see FIG. 7B).

With this configuration, dents are formed between adjacent bumps, and the first and second tooth trains 73 and 74 are each formed as a continuous bump/dent portion.

The first tooth train 73 is mounted on the top surface of a support member 711 with the bump/dent portion facing upward.

The second tooth train 74 is mounted on the bottom surface of a moving member 712 with the bump/dent portion facing downward.

When the second tooth train 74 approaches the first tooth train 73, the bump/dent portions of the first and second tooth trains 73 and 74 are engaged with each other (see FIG. 7C).

The moving member 712 is moved in the directions indicated by the arrows Sp and St in FIG. 7A so as to be close to and be separate from the fixed support member 711.

When the second tooth train 74 is moved to separate from the support member 711, it forms a gap, which is large enough to insert a sheet bundle 90, with the first tooth train 73.

This gap corresponds to a binding space 72As (see FIG. 4). The binding space 72As is set so that the top edge of the first tooth train 73 and the bottom edge of the second tooth train 74 are separated from each other by a predetermined distance K (see FIG. 5).

As shown in FIGS. 5 through 6B, the moving member 712 is movably mounted on pillars 713 fixed on the support member 711.

Portions of the moving member 712 adjacent to the pillars 713 are supported by a bar-like screw member 741, which is part of a moving mechanism.

As a result of the screw member 741 rotating in a predetermined direction, the moving member 712 is moved in a direction to be close to and be separate from the support member 711.

The screw member 741 is rotated by the rotational force of a drive motor 742 (see FIGS. 6A and 6B), which is a drive device for the moving mechanism.

A driven gear 743 is attached to a portion of the screw member 741 which projects downward of the support member 711. The bottom portion of the support member 711 is covered by a cover portion 714, as shown in FIGS. 5 and 6A.

The drive motor 742 is rotatable in the forward and reverse directions and is mounted on the support member 711.

A driving gear 744 is attached to an output shaft 742j of the drive motor 742, which projects downward of the support member 711.

Drive force of the drive motor 742 is transmitted from the driving gear 744 to the driven gear 743 via a predetermined reduction gear train 745.

This rotates the screw member 741 by the rotational force of the drive motor 742 in a predetermined direction by a predetermined amount.

For example, the rotation state (the number and the amount of rotation, for example) of the drive motor 742 is controlled based on detection information from a rotary encoder, which is not shown, provided in the support member 711.

The stapleless binder 71 is movably mounted on a guiding support member 75, as shown in FIG. 4.

The guiding support member 75 is a planar member provided with a guiding hole 751 (see FIG. 3). The shape of the guiding hole 751 corresponds to the moving range of the stapleless binder 71.

As illustrated in FIG. 3, the guiding hole 751 is formed as a linearly extending hole, which corresponds to the moving path of the stapleless binder 71. The guiding hole 751 also extends along the fold line 95, which will be discussed later.

In the stapleless binder 71, a support projection 715 (see FIG. 4) is provided under the support member 711. The support projection 715 is a bar-like projection which protrudes downward of the support member 711, and part of the support projection 715 is fitted in the guiding hole 751.

A moving driver 76 (see FIG. 4) is attached to the support projection 715.

The moving driver 76 includes a forward/reverse rotating drive motor, which is not shown, and a driving gear, which is not shown, driven by the rotational force from this drive motor.

The moving driver 76 causes this driving gear to engage with a rack gear, which is not shown, provided in the guiding support member 75, for example, along the guiding hole 751.

As a result of the moving driver 76 driving or being stopped, the stapleless binder 71 is guided to the guiding hole 751 of the guiding support member 75 and is shifted to a predetermined position and is then stopped.

At this time, in the moving driver 76, the driving gear is driven to rotate by the drive motor in a predetermined direction by a predetermined amount.

The stapleless binder 71 can shift to and stop at multiple binding positions P and a retreating position Ph shown in FIG. 3.

In FIG. 3, five binding positions P1, P2, P3, P4, and P5 are shown. However, the number of binding positions P is not limited to a particular number and may be a plural number other than five.

The binding positions P1, P2, P3, P4, and P5 shown in FIG. 3 are scattered in the direction along the fold line 95 of a sheet bundle 90 on the piling tray 62.

When stapleless binding processing is not performed, the stapleless binder 71 shifts to the retreating position Ph and waits until stapleless binding processing is performed next time.

The retreating position Ph is a position at which the entirety of the stapleless binder 71 is located outside the passage 56 (see FIG. 3) for a bundle sheet 90.

The stapleless binder 71 is disposed so that a virtual straight line VL (see FIG. 4) connecting the first tooth train 73 and the second tooth train 74 of the pressure-binding unit 72A is positioned at a predetermined angle (orientation).

As shown in FIGS. 4 and 7A, the virtual straight line VL is a line connecting the intermediate positions of the first and second tooth trains 73 and 74 in the passing direction of a sheet bundle 90. The virtual straight line VL is also parallel with the moving direction St and Sp of the second tooth train 74.

The stapleless binder 71 is disposed so that the virtual straight line VL substantially perpendicularly intersects with the leading binding portion of a sheet bundle 90 including the fold line 95 supplied from the pair of folding rollers 67A and 67B.

In the first exemplary embodiment, the stapleless binder 71 is disposed so that the virtual straight line VL tilts at an angle (orientation) in the opposite direction of the tilting direction of the piling surface 621 of the piling tray 62.

The reason why the stapleless binder 71 is arranged in this manner is that a sheet bundle 90 fed from the pair of folding rollers 67A and 67B advances while the leading portion of the sheet bundle 90 including the fold line 95 is curving downward by gravity, as illustrated in FIG. 10B. That is, the stapleless binder 71 is arranged so that the binding space 72As (see FIG. 4) can receive the leading portion of the sheet bundle 90 including the fold line 95, which curves downward, substantially perpendicularly to the virtual straight line VL.

Additionally, the stapleless binder 71 is disposed so that the pressure-binding unit 72A is positioned within a predetermined range, as shown in FIG. 4.

The predetermined range is a range from a feeding position NPe of the pair of folding rollers 67A and 67B to a position separated from the feeding position NPe by a predetermined distance L2.

The feeding position NPe is a position at a downstream edge of the contact portion NP in the transport direction of a sheet bundle 90. As stated above, the contact portion NP is a portion where the folding rollers 67A and 67B contact each other. The feeding position NPe may be an intermediate position (point) of the contact portion NP.

The above-described position separated from the feeding position NPe by the predetermined distance L2 is a position on a straight line EL connecting a downstream edge 73e of the first tooth train 73 and a downstream edge 74e of the second tooth train 74.

The predetermined distance L2 is half the length of the smallest one of sheets 9 formed into a sheet bundle 90. In this case, the length of the smallest one of the sheets 9 is the length of the smallest sheet 9 when the sheets 9 are being transported.

As illustrated in FIG. 2, in the sheet processing apparatus 5A, a sheet-bundle passing guiding member 57 for a sheet bundle is disposed.

The sheet-bundle passing guiding member 57 is a member that allows the leading portion of a sheet bundle 90 fed from the pair of folding rollers 67A and 67B to pass therethrough and guides the leading portion of the sheet bundle 90 toward the binding space 72As of the stapleless binder 71.

The sheet-bundle passing guiding member 57 is disposed in a region between the pair of folding rollers 67A and 67B and the stapleless binder 71 in the passage 56.

As shown in FIG. 4, the sheet-bundle passing guiding member 57 is constituted by a pair of guiding members 57A and 57B that are disposed with a gap therebetween in a substantially up-down direction to form a guiding space 57s. In the first exemplary embodiment, the guiding space 57s is formed as a space having a convex shape upward.

The guiding space 57s is not limited to a space having a convex shape. For example, the guiding space 57s may be a space having an obliquely extending shape.

As illustrated in FIG. 2, in the sheet processing apparatus 5A, a sheet-bundle output guiding member 58 is also disposed.

The sheet-bundle output guiding member 58 is a member that guides a sheet bundle 90 fed from the pair of folding rollers 67A and 67B toward the loading tray 591 of the loader 59.

The sheet-bundle output guiding member 58 is disposed on the side of the stapleless binder 71, which is separated from the side on which the pressure-binding unit 72A is provided. More specifically, the sheet-bundle output guiding member 58 is disposed in a range between the lower portion of the above-described side of the stapleless binder 71 and the position near one end of the loading tray 591.

The sheet-bundle output guiding member 58 is formed of a planar member.

### (Control Unit)

As illustrated in FIGS. 1 and 8, the image forming system 1 includes an image forming controller 14 and a sheet processing controller 15, which serve as a control unit.

The image forming controller 14 and the sheet processing controller 15 are each constituted by a processor, a storage, an input/output unit, and other components, none of which are shown. Another control unit, which will be discussed later, is also configured in a similar manner.

The processor of each of the image forming controller 14 and the sheet processing controller 15 obtains information required for performing a control operation and processes the obtained information based on a control program and control data stored in the storage. The processor of each of the image forming controller 14 and the sheet processing controller 15, for example, then transmits a signal for controlling the operation of a control target.

Examples of information required for performing a control operation is detection information and input information.

The image forming controller 14 is a portion that performs control operations regarding the operation of the image forming apparatus 2.

As illustrated in FIG. 8, a communication/input-output unit 16, a sheet size obtainer 17, and a sheet passing detector 18, for example, are connected to the image forming controller 14. This enables the image forming controller 14 to obtain required information, such as detection information and input information.

The communication/input-output unit 16 is a portion that sends and receives information with the external connection device 300 by performing communication and also inputs and outputs information into and from the external connection device 300. The sheet size obtainer 17 is a portion that obtains information concerning the size of a sheet 9.

An image forming operation controller 141, a sheet transport operation controller 142, and an operation display controller 143, for example, are also connected to the image forming controller 14. This enables the image forming controller 14 to perform certain operations, such as outputting a control signal to a control target.

The image forming operation controller 141 is a portion that controls the operation related to the image forming unit 20. The sheet transport operation controller 142 is a portion that controls the operation related to the sheet supply unit 30 including the sheet transport path Tr. The operation display controller 143 is a portion that controls the operation related to the operation display 45.

The sheet processing controller 15 is a portion that performs control operations regarding the operation of the sheet processing apparatus 5A.

As illustrated in FIG. 8, a number-of-sheet information obtainer 502, a sheet passing detector 503, and a binder position detector 504, for example, are connected to the sheet processing controller 15. This enables the sheet processing controller 15 to obtain required information, such as detection information and input information.

The number-of-sheet information obtainer 502 is a portion that obtains information on the number of sheets 9 to be formed into a sheet bundle 90. The number-of-sheet information obtainer 502 obtains information on the number of sheets 9 input from an external device or the operation display 45 into the image forming controller 14.

The sheet passing detector 503 is a portion that detects whether a sheet 9 or a sheet bundle 90 has passed through certain locations, such as the sheet guiding path 51, the folding device 60, and the loader 59. The sheet passing detector 503 is constituted by a detector, such as a sensor, which is not shown, disposed at a predetermined position at which a sheet 9 or a sheet bundle 90 passes.

The binder position detector 504 is a portion that detects the position to which the stapleless binder 71 is shifted. The binder position detector 504 is constituted by a detector, such as a sensor, which is not shown, disposed at a predetermined position near the guiding support member 75, for example.

A sheet transport operation controller 151, a sheet aligning operation controller 152, a folding operation controller 153, a binder position shifting controller 154, and a stapleless binding operation controller 155, for example, are connected to the sheet processing controller 15. This enables the sheet processing controller 15 to perform certain operations, such as outputting a control signal to a control target.

The sheet processing controller 15 is also connected to the image forming controller 14. This enables the sheet processing controller 15 to send and receive information required for control operations to and from the image forming controller 14.

The sheet processing controller 15 may be disposed in the image forming apparatus 2.

The sheet transport operation controller 151 is a portion that controls the transport operation for a sheet 9 or a sheet bundle 90 in certain components, such as the sheet guiding path 51, the piler 61, and the loader 59. The sheet aligning operation controller 152 is a portion that controls the aligning operation for a sheet 9 or a sheet bundle 90 performed by the bottom edge aligning member 63 and the side edge aligning member 64 of the piler 61.

The folding operation controller 153 is a portion that controls the operations of the press-bender 66 and the folding-transporter 67 of the folding device 60. Details of the operation of the folding-transporter 67 will be discussed later.

The binder position shifting controller 154 is a portion that controls the shifting operation of the stapleless binder 71. The stapleless binding operation controller 155 is a portion that controls stapleless binding processing performed by the stapleless binder 71.

### [Operation of Sheet Processing Apparatus]

The operation of the sheet processing apparatus 5A will now be described below.

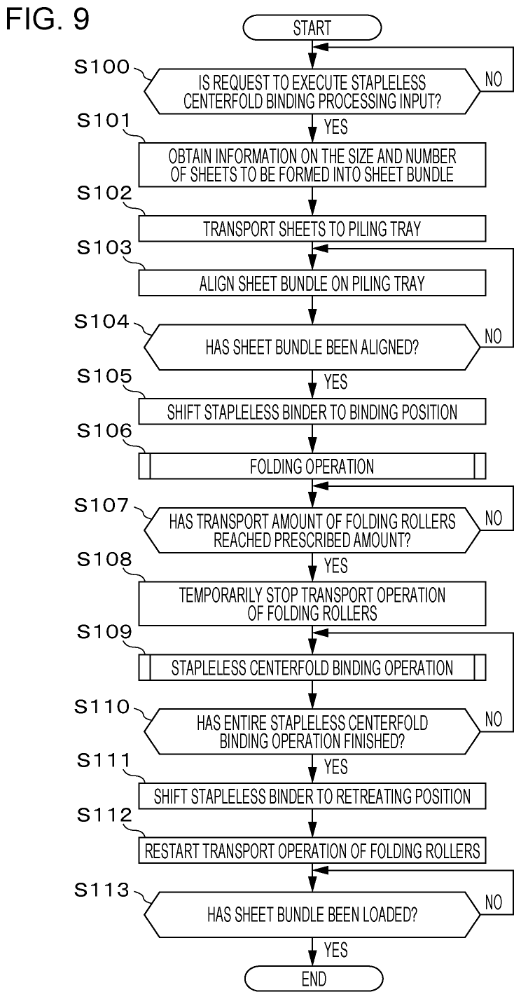

In step S100 of FIG. 9, the sheet processing apparatus 5A first determines whether a request to execute stapleless centerfold binding processing is input into the image forming system 1.

Stapleless centerfold binding processing is to bind a sheet bundle 90, which is folded in half by the folding device 60, with the stapleless binder 71.

In step S100, the sheet processing controller 15 makes the above-described determination by obtaining request information input from the external connection device 300 or the operation display 45 into the image forming apparatus 2.

If the image forming apparatus 2 has received a request to execute stapleless centerfold binding processing, the sheet processing controller 15 obtains the size and the number of sheets 9 to be formed into a sheet bundle 90 in step S101.

Information on the size and the number of sheets 9 is obtained from request information or selection information input into the image forming apparatus 2.

After the information on the size of the sheets 9 is obtained, the bottom edge aligning member 63 of the piler 61 shifts to the bottom edge aligning position on the piling tray 62 suitable for the size of the sheets 9 and is stopped.

The bottom edge aligning position is preset in accordance with the size of the sheets 9.

With this aligning operation, a sheet bundle 90 can be formed in the piler 61 in a state in which the folding portion 93 of the sheet bundle 90 faces the through-portion 625 on the piling tray 62.

Then, in step S102, in the sheet processing apparatus 5A, the sheet guiding path 51 sequentially transports a predetermined number of sheets 9 to be formed into a sheet bundle 90 to the piling tray 62 of the piler 61.

The sheets 9 are output from the image forming apparatus 2 and are guided to the sheet processing apparatus 5A.

Then, in step S103, in the sheet processing apparatus 5A, a sheet bundle 90 on the piling tray 62 is aligned. The sheet processing apparatus 5A then determines in step S104 whether this aligning operation has finished.

In this aligning operation, the push-in rotator 65 is driven to rotate in the predetermined direction.

With this rotating operation, the sheet 9 or the sheet bundle 90 on the piling tray 92 is pushed downward until the bottom edge of the sheet 9 or the sheet bundle 90 abuts against the bottom edge aligning member 63 and is aligned.

During the aligning operation, a pair of aligning members forming the side edge aligning member 64 are shifted.

The pair of aligning members touches the front edge and the back edge of the sheet bundle 90 on the piling tray 62 so that the side edges, that is, the front edge and the back edge of the sheet bundle 90, are aligned.

As a result of performing the aligning operation in step S103, a sheet bundle 90 constituted by the predetermined number of sheets 9 stacked and aligned in order is formed on the piling surface 621 of the piling tray 62.

The sheet bundle 90 is formed in a state in which the folding portion 63 faces the through-portion 625 of the piling tray 62 (see FIG. 2).

If it is determined in step S104 that the aligning operation has finished, the stapleless binder 71 shifts to a binding position in step S105.

At this time, while being guided by the guiding support member 75, the stapleless binder 71 shifts from the retreating position Ph to a predetermined binding position P and is stopped. The predetermined binding position P is one of the binding positions P1 through P5 shown in FIG. 3.

The stapleless binder 71 may start shifting to the binding position at a different timing, for example, after information on the size of the sheets 9 is obtained in step S101.

Then, the sheet processing apparatus 5A performs a half-folding operation in step S106.

In the half-folding operation, as illustrated in FIG. 10A, the press-bender 66 first presses and bends the folding portion 93 of the sheet bundle 90 on the piling tray 62.

More specifically, in the press-bender 66, the pushing member 661 is shifted by the shifter 662 toward the sheet bundle 90 by a predetermined amount.

Then, the forward end of the pushing member 661 passes through the through-portion 625 of the piling tray 62 and then touches and pushes the folding portion 93 of the sheet bundle 90 by the predetermined amount.

With this operation, the sheet bundle 90 is push-bent in a state in which the folding portion 93 at the center is raised in an inverted V shape substantially perpendicularly to the piling surface 621 of the piling tray 62.

The sheet bundle 90 is pushed until a bent portion is inserted into the contact portion NP where the folding rollers 67A and 67B forming the folding-transporter 67 contact each other. The bent portion is constituted by two sections facing each other with the folding portion 93 in the middle.

The folding rollers 67A and 67B start to rotate in the directions indicated by the arrows in FIG. 4 at the timing at which the portion of the sheet bundle 90 bent by the pushing member 661 reaches the contact portion NP. The folding rollers 67A and 67B may start to rotate at the timing at which the bent portion of the sheet bundle 90 touches the contact portion NP.

In the half-folding operation, as shown in FIG. 10B, the folding rollers 67A and 67B transport the sheet bundle 90 in a state in which the sheet bundle 90 is being pinched in the contact portion NP with the bent portion as the leading end.

At this time, when the leading bent portion is passing through the contact portion NP, the sheet bundle 90 is subjected to pressure and is folded. The leading bent portion substantially corresponds to the folding portion 93.

The sheet bundle 90 is transported by a predetermined amount in a state in which the leading bent portion is folded.

As a result, the sheet bundle 90 is folded in two in a state in which the leading bent portion becomes the fold line 95, as illustrated in FIGS. 10B and 11B. That is, the sheet bundle 90 is folded in half.

The sheet bundle 90 is output from the contact portion NP having the fold line 95 as the leading end.

The sheet bundle 90 is then transported to the binding space 72As of the stapleless binder 71.

The sheet bundle 90 advances so that the leading end portion including the fold line 95 passes through the guiding space 57s of the passing guiding member 57. This can stably guide the leading end portion including the fold line 95 of the sheet bundle 90 to the binding space 72As of the stapleless binder 71.

In the half-folding operation, the sheet processing controller 15 determines in step S107 whether the transport amount of the pair of folding rollers 67A and 67B has reached a prescribed amount.

If the transport amount of the folding rollers 67A and 67B is found to have reached the prescribed amount, the transport operation of the folding rollers 67A and 67B for the sheet bundle 90 is temporarily stopped in step S108.

The above-described transport amount is a transport distance D1 from the feeding position NPe of the folding rollers 67A and 67B to a temporary stop position Te, as shown in FIG. 10B.

The temporary stop position Te is a position located outward from the above-described straight line EL by a dimension α, which will be discussed later. A line TL shown in FIGS. 4 and 10B is a virtual extension line which passes through the temporary stop position Te and which is parallel with the straight line EL.

Strictly speaking, in the first exemplary embodiment, the transport distance D1 is the length of a curved line starting from the feeding position NPe to the temporary stop position Te.

The above-described prescribed transport amount is the amount (L2+α) obtained by adding the dimension α to the above-described distance L2.

The predetermined distance L2 is the distance from the feeding position NPe of the pair of folding rollers 67A and 67B to the first and second downstream edges 73e and 74e of the pressure-binding unit 72A (see FIG. 4). The dimension α is equal to the length from the fold line 95 to a portion of the sheet bundle 90 to be bound without staples located inward from the fold line 95 (see FIG. 11C).

That is, the prescribed transport amount is the amount obtained by adding the dimension α to half the length (L2) of the smallest one of sheets 9 formed into a sheet bundle 90. In this case, the length of the smallest one of the sheets 9 is the length of the smallest sheet 9 when the sheets 9 are being transported.

Strictly speaking, in the first exemplary embodiment, the prescribed transport amount is the length of the curved line or the distance of the transport path from the feeding position NPe to the temporary stop position Te.

In the first exemplary embodiment, the control operation for temporarily stopping the transport operation of the folding rollers 67A and 67B when the transport amount of the folding rollers 67A and 67B has reached the prescribed amount is implemented in the following manner, for example.

When the required amount of time from a certain time point to a time point at which the transport amount of the folding rollers 67A and 67B reaches the above-described prescribed amount has passed, the rotation of the pair of folding rollers 67A and 67B is stopped.

For example, a sheet detection sensor (not shown) is disposed at a position separated from the output side of the contact portion NP where the folding rollers 67A and 67B contact each other by a certain distance Ls (not shown). This sheet detection sensor is an example which forms part of the sheet passing detector 18 shown in FIG. 8. The sheet detection sensor detects the time at which the fold line 95 of the sheet bundle 90 fed from the pair of folding rollers 67A and 67B reaches the position of the sheet detection sensor.

The rotation of the folding rollers 67A and 67B is stopped when the required amount of time from the time point detected by the sheet detection sensor to the time point at which the transport amount reaches the above-described prescribed amount has passed.

The time point (time) at which the transport amount reaches the above-described prescribed amount can be calculated by dividing the above-described prescribed amount (L2+α) by the transport speed of the folding rollers 67A and 67B. The required amount of time from the time detected by the sheet detection sensor to the time at which the transport amount reaches the above-described prescribed amount can be calculated by dividing the value obtained by subtracting the distance Ls from the prescribed amount (L2+α) by the transport speed of the folding rollers 67A and 67B.

When the transport operation of the folding rollers 67A and 67B is temporarily stopped in step S108, the leading end portion of the sheet bundle 90 including the fold line 95 has entered the binding space 72As of the stapleless binder 71.

The sheet bundle 90 is stopped in a state in which the fold line 95 has reached the temporary stop position Te (see FIG. 10B).

As shown in FIG. 4, the temporary stop position Te is a position located outward from the straight line EL, which connects the downstream edge 73e of the first tooth train 73 and the downstream edge 74e of the second tooth train 74, by the dimension α.

When the sheet bundle 90 is stopped, the portion near the fold line 95 of the sheet bundle 90 faces the first and second tooth trains 73 and 74 of the pressure-binding unit 72A.

After step S108, in the sheet processing apparatus 5A, a stapleless centerfold binding operation is performed by the stapleless binder 71 in step S109.

The stapleless binder 71 executes stapleless centerfold binding processing at the requested (first) binding position.

More specifically, in the stapleless binder 71, the moving member 712 is lowered in the direction indicated by the arrow Sp to approach the support member 711.

With this operation, the second tooth train 74 on the moving member 712 approaches the first tooth train 73 and sandwiches part of the sheet bundle 90 with the first tooth train 73 so as to pressure-bind the sheet bundle 90. Part of the sheet bundle 90 sandwiched between the first and second tooth trains 73 and 74 is the portion near the fold line 95.

Then, the moving member 712 is raised in the direction indicated by the arrow St so as to separate from the support member 711.

With this operation, the second tooth train 74 on the moving member 712 is separated from the first tooth train 73. Then, the binding space 72As is secured between the first and second tooth trains 73 and 74.

As a result, in the sheet bundle 90, the portion near the fold line 95, which is sandwiched and pressure-bound between the first and second tooth trains 73 and 74, is turned into a portion 96 which has been bound without staples (see FIG. 11C).

The portion 96 has a wavy shape by following the shape of the bump/dent portion of the first and second tooth trains 73 and 74. In the portion 96 of the sheet bundle 90, the fibers of the sheets 9 folded on each other are interwoven and are combined with each other.

In this manner, the sheet bundle 90 folded and bent in the folding device 60 can be bound without staples by the stapleless binder 71.

That is, the sheet bundle 90 is bound in half without staples, as illustrated in FIG. 11C. The portion 96 in FIG. 11C is a portion bound or to be bound without staples.

If a request to perform stapleless centerfold binding processing at another binding position is input into the image forming apparatus 2, the stapleless binder 71 shifts to the next binding position and is stopped. The stapleless binder 71 then executes stapleless centerfold binding processing at this position in a similar manner.

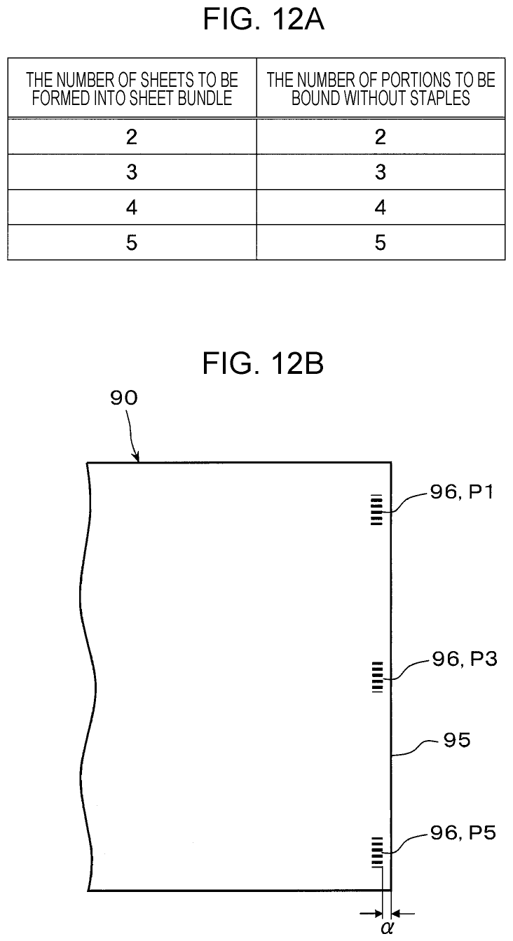

The sheet processing apparatus 5A performs stapleless binding processing such that, as the number of sheets 9 to be formed into a sheet bundle 90 becomes greater, the number of portions 96 of the sheet bundle 90 to be bound also becomes greater. The portions 96 to be bound are portions to be bound without staples in the direction along the fold line 95 of the sheet bundle 90, as illustrated in FIG. 12B.

In the first exemplary embodiment, as shown in FIG. 12A, when the number of sheets 9 to be formed into a sheet bundle 90 is two, the number of portions 96 to be bound without staples is also two. As the number of sheets 9 to be formed into a sheet bundle 90 is increased by one, the number of portions 96 to be bound without staples is also increased by one. That is, the number of portions 96 to be bound is set to a suitable number in accordance with the number of sheets 9.

The positions of portions 96 to be bound are arranged at suitable positions in accordance with the dimension of the sheets 9 which are being transported. The dimension of the sheets 9 is a dimension perpendicular to the transport direction of the sheets 9 in the sheet processing apparatus 5A.

In the example in FIG. 12B, the number of sheets 9 to be formed into a sheet bundle 90 is three and the number of portions 96 to be bound is three.

The positions of the portions 96 of the sheet bundle 90 shown FIG. 12B are determined based on the sheet 9 having the largest dimension among the sheets 9 which are being transported.

In this case, the topmost portion 96 in FIG. 12B is the portion 96 bound by the stapleless binder 71 located at the binding position P1 (see FIG. 3), the bottommost portion 96 in FIG. 12B is the portion 96 bound by the stapleless binder 71 located at the binding position P5 (see FIG. 3), and the intermediate portion 96 in FIG. 12B is the portion 96 bound by the stapleless binder 71 located at the binding position P3 (see FIG. 3).

In step S110 in FIG. 9, the sheet processing apparatus 5A determines whether the entire stapleless centerfold binding operation has finished.

If it is determined in step S110 that the entire stapleless centerfold binding operation has finished, the stapleless binder 71 shifts from the final binding position P to the retreating position Ph and is stopped in step S111.

The stapleless binder 71 waits at the retreating position Ph until a request to execute stapleless centerfold binding processing is input next time.

When the stapleless binder 71 located at the retreating position Ph does not perform binding processing, it does not interfere with the movement of the bound sheet bundle 90 to the loader 59 via the passage 56.

After step S111, the transport operation of the pair of folding rollers 67A and 67B, which is temporarily stopped, is restarted in step S112.

Then, the sheet bundle 90, which has been folded and bent by the pair of folding rollers 67A and 67B, is sent out to the loader 59 by receiving the transport force of the folding rollers 67A and 67B again.

The sheet bundle 90 is then transported to the loader 59 while being guided by the sheet-bundle output guiding member 58 by passing through the passage 56 (see FIG. 10C).

The sheet bundle 90, which is placed on the storage surface 592 of the loading tray 591, receives the transport force of the transport belt device 595. By this transport force, the sheet bundle 90 is moved toward the sheet bundle stoppage portion 593 and is stored.

In step S113 in FIG. 9, the sheet processing apparatus 5A determines whether the sheet bundle 90 subjected to stapleless centerfold binding processing has been loaded in the loader 59.

If it is determined in step S113 that the sheet bundle 90 has been loaded in the loader 59, the requested stapleless centerfold binding processing has been completed.

As described above, in the image forming system 1, a sheet bundle 90 formed by stacking multiple sheets 9 supplied from the image forming apparatus 2 can be bound at the position of a portion near a fold line 95 without using staples in the sheet processing apparatus 5A.

The sheets 9 supplied from the image forming apparatus 2 may not necessarily be sheets 9 on which images are formed, and may be sheets 9 without images.

In the sheet processing apparatus 5A, the stapleless binder 71 performs binding processing for a sheet bundle 90 folded and bent by the folding device 60 while sandwiching and holding the sheet bundle 90 with a pair of folding rollers 67A and 67B.

This can stabilize the binding processing of the stapleless binder 71, compared with when the stapleless binder 71 performs binding processing without holding a sheet bundle 90 with a pair of folding rollers 67A and 67B.

In the sheet processing apparatus 5A, the pair of folding rollers 67A and 67B temporarily stops transporting a sheet bundle 90 in accordance with the position of the binding unit 72 of the stapleless binder 71.

The pair of folding rollers 67A and 67B stops transporting the sheet bundle 90 when a portion of the sheet bundle 90 to be bound faces the first and second tooth trains 73 and 74 of the pressure-binding unit 72A, which is the binding unit 72.

That is, in the sheet processing apparatus 5A, the position of a portion of a sheet bundle 90 to be bound by the stapleless binder 71 is controlled by the transport amount of the folding rollers 67A and 67B (transport distance D1). The position of a portion of a sheet bundle 90 to be bound is a position located inward from the fold line 95 by a predetermined dimension α.

With this configuration, the position of a portion of a sheet bundle 90 to be bound by the stapleless binder 71 can be controlled without using a specific element to stop the sheet bundle 90 at a binding position. For example, it is not necessary to use a stop plate to stop a sheet bundle 90 by striking it against this plate.

### Second Exemplary Embodiment

An image forming system according to a second exemplary embodiment includes a staple binder 77 (an example of a staple binding device) as the binding device 70 in addition to the elements of the image forming system 1 according to the first exemplary embodiment.

More specifically, the staple binder 77 is added to the sheet processing apparatus 5A, as indicated by the long dashed double-dotted lines in FIGS. 1 and 2.

The staple binder 77 is a device that binds a sheet bundle 90 in the piler 61 with staples before the sheet bundle 90 is folded by the folding device 60.

For this reason, the staple binder 77 is disposed farther upward than the folding-transporter 67 disposed near the piling tray 62 of the piler 61, for example.

As the staple binder 77, a known staple binder can be used.

For example, a staple binder including a mover 771 and a staple bender 772 (see FIG. 2) is applicable to the stapler binder 77.

The mover 771 is a moving portion that is moved to insert a staple into a folding portion 93 of a sheet bundle 90 while holding the staple. The mover 771 is disposed on the side of the piling surface 621 of the piling tray 62 so as to separate from the piling surface 621 at a predetermined distance.

The staple bender 772 is a portion that receives the end of a staple which has passed through a sheet bundle 90 by being pressed by the mover 771 and bends the end of the staple in a predetermined direction. The staple bender 772 is disposed on the opposite side of the piling tray 62 so as to face the mover 771 with the piling surface 621 interposed therebetween.

In the piling tray 62, a through-portion is formed which allows the staple binder 77 to perform staple binding processing.

In a manner similar to the stapleless binder 71, the staple binder 77 is mounted to be movable to a predetermined binding position along the widthwise direction of the piling tray 62 while being guided by a guiding support member, which is not shown. The widthwise direction of the piling tray 62 is the direction in which the front edge 62c and the back edge 62d of the piling tray 62 are linked with each other.

With this configuration, the staple binder 77 is also shifted to a predetermined binding position and is stopped while being guided by the guiding support member (not shown). For the staple binder 77 as well as for the stapleless binder 71, multiple binding positions are formed.

The image forming system (and the sheet processing apparatus 5A) includes a selector 19 for selecting the binding method for a sheet bundle 90.

The selector 19 selects whether to execute stapleless binding processing using the stapleless binder 71 or staple binding processing using the staple binder 77 as binding processing for a sheet bundle 90.

The selector 19 is formed as a function for performing a selecting operation, which is part of the functions of the operation display 45, for example. The selector 19 is added as a function of the external connection device 300.

In the image forming system according to the second exemplary embodiment, a staple binding operation controller 156 is connected to the sheet processing controller 15, as indicated by the long dashed double-dotted lines in FIG. 8.

The staple binding operation controller 156 is a portion that controls the operation of the staple binder 77.

As part of the operation control processing for the operation display 45, the operation display controller 143 displays a selection screen and allows for a selection input operation using the selector 19.

As in the first exemplary embodiment, in the image forming system according to the second exemplary embodiment, the image forming apparatus 2 can form an image on a sheet 9.

In the image forming system according to the second exemplary embodiment, the sheet processing apparatus 5A executes the following centerfold binding processing.

### [Operation of Sheet Processing Apparatus]

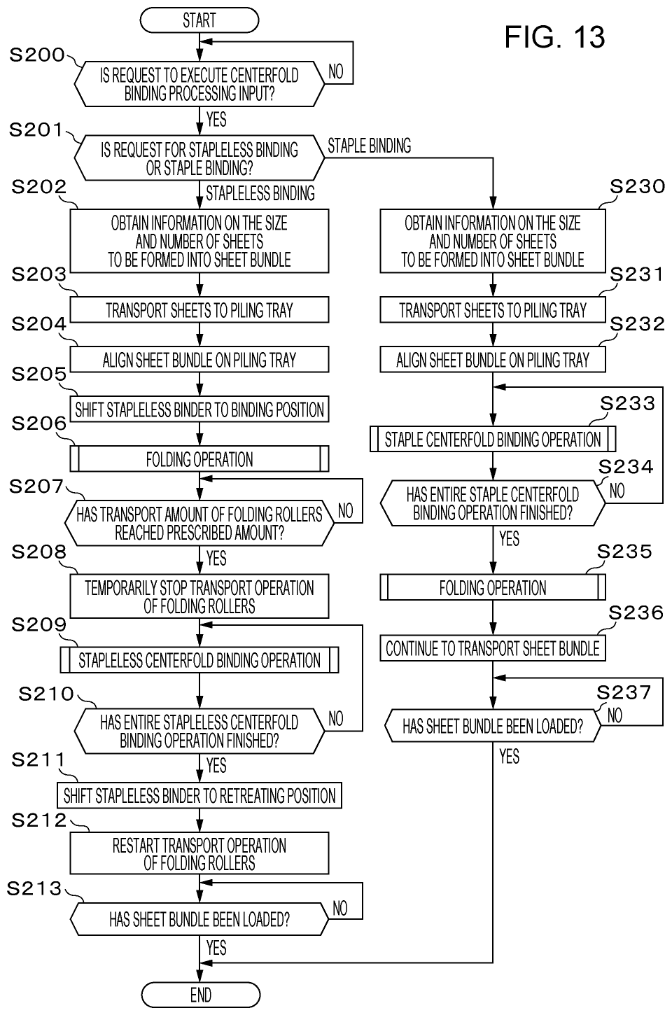

In step S200 of FIG. 13, the sheet processing apparatus 5A first determines whether a request to execute centerfold binding processing is input into the image forming system 1.

If the image forming apparatus 2 has received a request to execute centerfold binding processing, the sheet processing apparatus 5A makes a determination regarding the centerfold binding method in step S201.

More specifically, the sheet processing apparatus 5A determines whether the request is a request for stapleless binding processing or staple binding processing.

The sheet processing controller 15 makes the above-described determination by obtaining request information input from the external connection device 300 or the operation display 45 into the image forming apparatus 2.

If it is determined in step S201 that the request is for stapleless binding processing, steps S202 through S213 in FIG. 13 are executed.

Details of steps S202 through S213 are the same as those of steps S101 through S103 and S105 through S113 in the first exemplary embodiment.

If it is determined in step S201 that the request is for staple binding processing, steps S230 through S232 in FIG. 13 are executed.

In step S230, information on the size and the number of sheets 9 to be formed into a sheet bundle 90 is obtained. In step S231, a predetermined number of sheets 9 are transported to the piling tray 62. Then, in step S232, a sheet bundle 90 on the piling tray 62 is aligned.

Details of steps S230 through S232 are the same as those of steps S101 through S103 in the first exemplary embodiment.

After the sheet bundle 90 has been aligned in step S232, a staple centerfold binding operation is performed in step S233.

In the staple centerfold binding operation, the position of the sheet bundle 90 on the piling tray 62 is first adjusted in accordance with the length of the sheet bundle 90. In this case, the length of the sheet bundle 90 is the length when the sheet bundle 90 is transported. That is, the position of the sheet bundle 90 is adjusted so that the folding portion 93 of the sheet bundle 90 faces a binding portion 773 (see FIG. 2) of the staple binder 77. This position adjustment is performed by shifting and stopping the bottom edge aligning member 63.

Then, in the staple centerfold binding operation in step S233, after the position adjustment of the sheet bundle 90, the staple binder 77 performs staple binding processing for the sheet bundle 90.

Then, the sheet bundle 90 on the piling tray 62 is bound at the position of the folding portion 93 with a staple. That is, the sheet bundle 90 is bound by saddle stitching.

If a request to perform staple centerfold binding processing at another binding position is input into the image forming apparatus 2, the staple binder 77 shifts to the next binding position and is stopped. The staple binder 77 then executes staple centerfold binding processing at this position in a similar manner.

Then, in step S234, the sheet processing apparatus 5A determines whether the entire staple centerfold binding operation in step S233 has finished.

If the entire staple centerfold binding operation is found to have finished, a folding operation using the folding device 60 is performed in step S235.

In the folding operation in step S235, the position of the sheet bundle 90 is first adjusted so that the folding portion 93 bound with a staple faces the through-portion 625 of the piling tray 62. This position adjustment is performed by shifting and stopping the bottom edge aligning member 63.

Then, in the folding operation, the press-bender 66 of the folding device 60 presses and bends the folding portion 93 of the sheet bundle 90 on the piling tray 62.

In the folding operation, a pair of folding rollers 67A and 67B, which forms the folding-transporter 67 of the folding device 60, transports the sheet bundle 90 by sandwiching the folding portion 93 press-bent by the press-bender 66 as the leading portion.

When the leading bent portion of the sheet bundle 90 is passing through the contact portion NP where the folding rollers 67A and 67B contact each other, the sheet bundle 90 is subjected to pressure and is folded.

The sheet bundle 90 is transported to the loader 59 in a state in which the leading bent portion is folded.

While staple centerfold binding is being performed, the stapleless binder 71 retreats to the retreating position Ph outside the passage 56.

With the above-described operation, the sheet bundle 90 is folded in two in a state in which the leading end portion, which is stapled and bent, is used as the fold line 95. That is, the sheet bundle 90 is folded in half.

The sheet bundle 90 is fed from the contact portion NP with the fold line 95 as the leading end.

Then, in the sheet processing apparatus 5A, the pair of folding rollers 67A and 67B continues to transport the sheet bundle 90 in step S236.

The folded sheet bundle 90 is transported to the loader 59 while being guided by the sheet-bundle output guiding member 58 by passing through the passage 56.

The sheet bundle 90, which is placed on the storage surface 592 of the loading tray 591 of the loader 59, receives the transport force of the transport belt device 595. By this transport force, the sheet bundle 90 is moved toward the sheet bundle stoppage portion 593 and is stored.

In step S237, the sheet processing apparatus 5A determines whether the sheet bundle 90 subjected to staple centerfold binding processing has been loaded in the loader 59.

If it is determined in step S237 that the sheet bundle 90 has been loaded in the loader 59, the requested staple centerfold binding processing has been completed.

As described above, as in the first exemplary embodiment, in the image forming system according to the second exemplary embodiment, a sheet bundle 90 formed by stacking multiple sheets 9 supplied from the image forming apparatus 2 can be bound at the position of a portion near a fold line 95 without using staples.

In the image forming system according to the second exemplary embodiment, in the sheet processing apparatus 5A, a sheet bundle 90 formed by stacking multiple sheets 9 supplied from the image forming apparatus 2 can also be bound at the position of a folding portion 93 with staples.

In the sheet processing apparatus 5A according to the second exemplary embodiment, more bundles 90A subjected to stapleless centerfold binding processing can be loaded in the loader 59 than sheet bundles 90B subjected to staple centerfold binding processing.

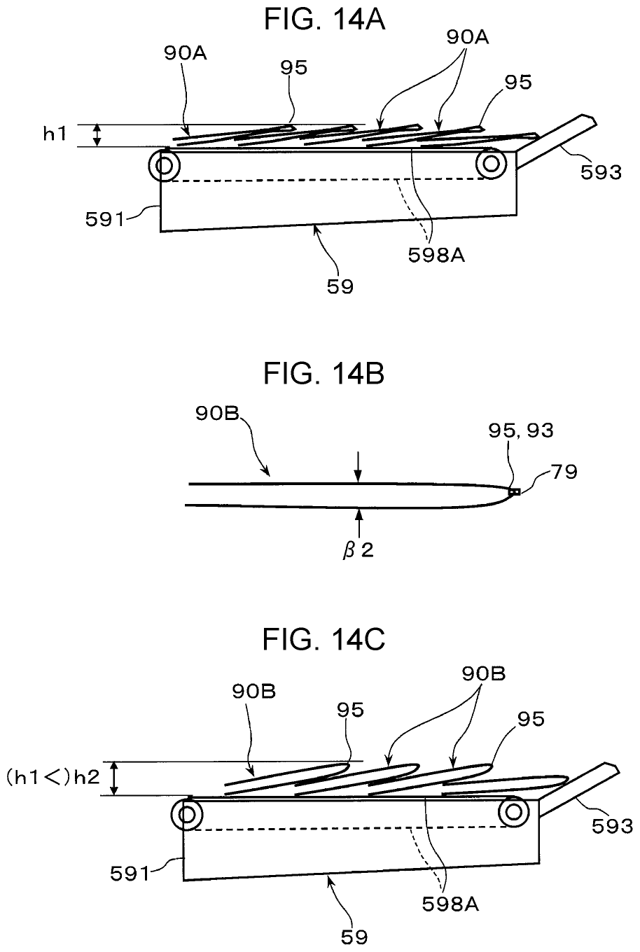

This is because the expansion amount (thickness) β1 of a sheet bundle 90A does not become large (see FIG. 11C). That is, the expansion amount β1 of the sheet bundle 90A is smaller than the expansion amount (thickness) β2 of a sheet bundle 90B bound with a staple 79 (see FIG. 14B).

Hence, the stacking amount (height) h1 of sheet bundles 90A loaded and stored in the loader 59 also becomes smaller, as illustrated in FIG. 14A. As a result, the sheet bundles 90A become less bulky and are easy to store in the loader 59 and more sheet bundles 90A can be stored.

In contrast, the stacking amount (height) h2 of sheet bundles 90B in the loader 59 becomes larger than the stacking amount h1 of the sheet bundles 90A, as illustrated in FIG. 14C. As a result, the sheet bundles 90B become bulkier and are difficult to be stored in the loader 59 and less sheet bundles 90B are stored.

### Third Exemplary Embodiment

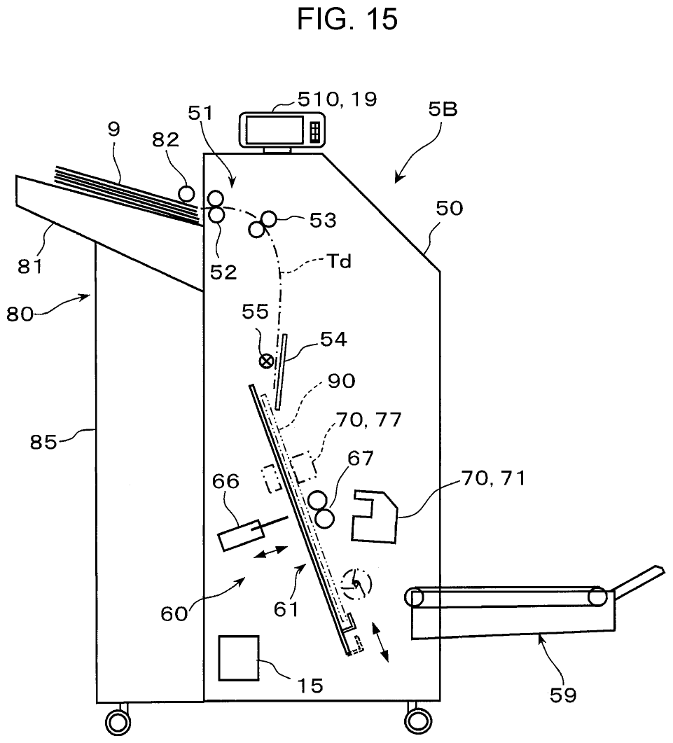

FIG. 15 illustrates a sheet processing apparatus 5B according to a third exemplary embodiment.

The sheet processing apparatus 5B is different from the sheet processing apparatus 5A according to the first exemplary embodiment principally in that a sheet supply device 80 is provided instead of the image processing apparatus 2. The configuration of the other elements is substantially the same as that of the sheet processing apparatus 5A.

The sheet supply device 80 includes a sheet storage 81 provided on one side surface of the housing 50 of the sheet processing apparatus 5B.

The sheet storage 81 has a storage surface on which multiple sheets 9 can be loaded and stored. Sheets 9 stored in the sheet storage 81 are sheets that at least require centerfold binding.

The sheet storage 81 includes a feeder 82 that feeds sheets 9 placed on the storage surface one by one to the inside of the housing 50.

The sheet supply device 80 also includes a housing 85, which is integrally formed with the housing 50, downward of the sheet storage 81. Required parts, for example, can be disposed within the space of the housing 85.

The sheet supply device 80 outputs sheets 9 fed from the sheet storage 81 to the sheet guiding path 51 of the sheet processing apparatus 5B.

The sheet supply device 80 also includes an operation display 510.

The operation display 510 includes an operation unit and a display unit, as in the operation display 45 in the first exemplary embodiment. By using the operation display 510, information required for binding processing, for example, is input and selected, and the state and the operation content of the sheet processing apparatus 5B are displayed.

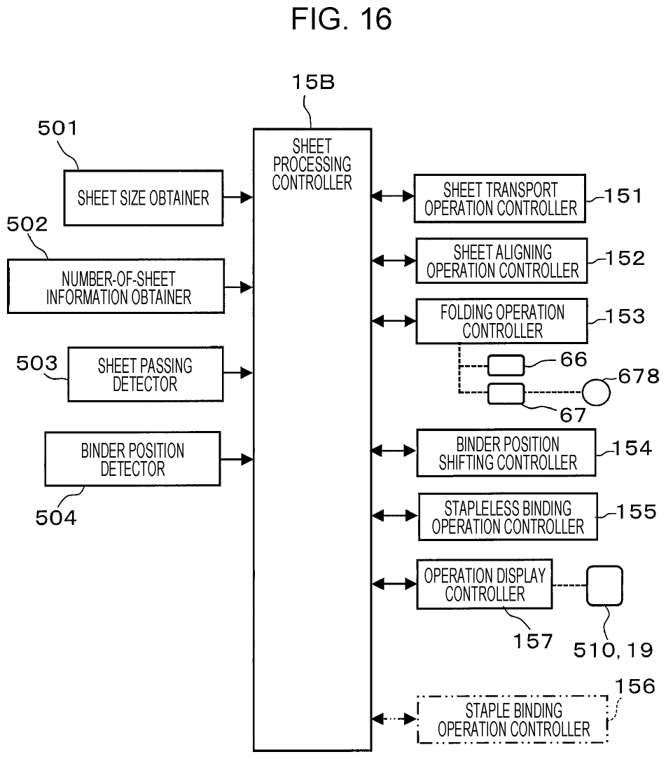

The sheet supply device 80 includes a sheet processing controller 15B as a control unit, as illustrated in FIG. 16.

The sheet processing controller 15B is different from the sheet processing controller 15 (see FIG. 8) of the first exemplary embodiment in that a sheet size obtainer 501 and an operation display controller 157 are connected to the sheet processing controller 15B, in addition to the elements connected to the sheet processing controller 15. The configuration of the other elements is substantially the same as that of the sheet processing controller 15.

The sheet size obtainer 501 is a portion that obtains information on the size of a sheet 9. Information on the size of a sheet 9 is obtained from information input from the operation display 510.

The operation display controller 157 is a portion that controls the operation and display of the operation display 510.

The sheet processing apparatus 5B executes processing regarding a stapleless centerfold binding operation in a manner similar to the sheet processing apparatus 5A of the first exemplary embodiment (see FIG. 9, for example).

In the sheet processing apparatus 5B, therefore, a sheet bundle 90 formed by stacking multiple sheets 9 supplied from the sheet supply device 80 can be bound at the position of a portion near a fold line 95 without using staples.

As in the sheet processing apparatus 5A of the second exemplary embodiment, the sheet processing apparatus 5B may also include a staple binder 77 as a binding device 70, as indicated by the long dashed double-dotted lines in FIG. 15.

In this case, the sheet processing apparatus 5B may also include a selector 19 for selecting the binding method for a sheet bundle 90, as in the second exemplary embodiment.

In this case, the sheet processing apparatus 5B executes centerfold binding processing in accordance with whether the stapleless binding method or the staple binding method is selected, as in the sheet processing apparatus 5A of the second exemplary embodiment (see FIG. 13).

The sheet processing apparatus 5B can select whether to bind a sheet bundle 90 at the position of a portion near a fold line 95 with or without staples and execute binding processing accordingly.

### Modified Examples

The present disclosure it not limited to the configurations of the first through third exemplary embodiments. That is, various modifications and alterations can be made without departing from the spirit and the scope of the disclosure.

The disclosure encompasses the following modified examples, for example.

In the first through third exemplary embodiments, as the binding positions P for the stapleless binder 71, five positions P1 through P5 are shown in FIG. 3, together with the setting locations. However, the number and the setting locations of binding positions are not limited to a particular number and location and may be set as desired.

As a portion 96 of a sheet 9 to be bound by the stapleless binder 71 without a staple, a desired portion may be selected and set by a user.

The retreating position Ph for the stapleless binder 71 is not limited to a position outside the passage 56 on the far side. The retreating position Ph may be a position outside the passage 56 on the near side or one of the upper and lower sides if a retreating space can be secured.

The sheet processing apparatus 5A according to the first and second exemplary embodiments is not limited to a device connected to the image forming apparatus 2 as a separate device. The sheet processing apparatus 5A may be a device built into the housing 10 as part of the image forming apparatus 2.

The sheet processing apparatuses 5A and 5B according to the first through third exemplary embodiments may be equipped with a device that executes another type of processing on a sheet 9 or a sheet bundle 90. Examples of such a device are a punching device for forming punch holes and a slip sheet supply device for inserting a slip sheet into a sheet bundle 90.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### (Appendix)

(((1)))

A sheet processing apparatus comprising:
a folding device that folds a sheet bundle which is formed of a plurality of sheets stacked on each other; and
a stapleless binding device including a binding unit that binds the sheet bundle at a position of a portion near a fold line without using a staple, the fold line being formed as a result of the folding device folding the sheet bundle.
   (((2)))

The sheet processing apparatus according to (((1))), wherein:
the folding device includes:
   a piler that piles a plurality of sheets to form a sheet bundle;
   a press-bender that presses and bends a portion of the sheet bundle placed in the piler, the portion of the sheet bundle being a portion to be folded; and
   a folding-transporter that transports the sheet bundle in such a manner as to pinch and fold the sheet bundle having the portion pressed and bent by the press-bender as a leading end, and
the folding-transporter temporarily stops transporting the sheet bundle in accordance with a position of the binding unit.
   (((3)))

The sheet processing apparatus according to (((1))) or (((2))), wherein the stapleless binding device is disposed to be movable between a binding position and a retreating position, the binding position being a position at which the stapleless binding device approaches the sheet bundle to perform binding processing, the retreating position being a position to which the stapleless binding device retreats from the sheet bundle, and the stapleless binding device moves from the retreating position to the binding position when performing the binding processing.

(((4)))

The sheet processing apparatus according to (((2))), wherein the position of the sheet bundle to be bound by the stapleless binding device is controlled in accordance with a transport amount of the folding-transporter, the transport amount being an amount by which the folding-transporter transports the sheet bundle before the folding-transporter temporarily stops transporting the sheet bundle.

(((5)))

The sheet processing apparatus according to (((2))), wherein:
the binding unit of the stapleless binding device is a pressure-binding unit that binds the sheet bundle at the position of the portion near the fold line by applying pressure to the portion near the fold line; and
the pressure-binding unit is disposed within a range from a feeding position of the folding-transporter to a position separated from the feeding position by half a length of a smallest one of the plurality of sheets formed into the sheet bundle, the feeding position of the folding-transporter being a position from which the sheet bundle is transported, the length of the smallest one of the plurality of sheets being the length of the smallest sheet when the sheets are being transported.
   (((6)))

The sheet processing apparatus according to (((3))), further comprising:
a loader that loads the sheet bundle which has passed through the folding device, the sheet bundle being supplied to the loader in a state in which the fold line is the leading end; and
a passage that allows the sheet bundle to pass through the passage from the folding device to the loader,
wherein the binding position is set within the passage and the retreating position is set outside the passage.
   (((7)))

The sheet processing apparatus according to one of (((1))) to (((6))), wherein the stapleless binding device performs binding processing in such a manner that, as the number of the sheets to be formed into the sheet bundle becomes greater, the number of portions to be bound in a direction along the fold line of the sheet bundle becomes greater.

(((8)))

The sheet processing apparatus according to (((7))), wherein, when the number of the sheets to be formed into the sheet bundle is two, the number of portions to be bound is two, and, as the number of the sheets to be formed into the sheet bundle is increased by one, the number of portions to be bound is increased by one.

(((9)))

The sheet processing apparatus according to one of (((1))) to (((8))), further comprising:
a staple binding device that binds the sheet bundle with a staple before the folding device folds the sheet bundle; and
a selector that selects whether to perform stapleless binding processing using the stapleless binding device or staple binding processing using the staple binding device as binding processing for the sheet bundle.
   (((10)))

An image forming system comprising:
an image forming apparatus that forms an image on a sheet; and
a sheet processing apparatus that performs binding processing for a sheet bundle which is formed by stacking a plurality of sheets supplied from the image forming apparatus,
wherein the sheet processing apparatus is the sheet processing apparatus according to one of (((1))) to (((9))).

What is claimed is:

1. A sheet processing apparatus comprising:
a folding device that folds a sheet bundle which is formed of a plurality of sheets stacked on each other; and
a stapleless binding device including a binding unit that binds the sheet bundle at a position of a portion near a fold line without using a staple, the fold line being formed as a result of the folding device folding the sheet bundle.

2. The sheet processing apparatus according to claim 1, wherein:
the folding device includes:
a piler that piles a plurality of sheets to form a sheet bundle;
a press-bender that presses and bends a portion of the sheet bundle placed in the piler, the portion of the sheet bundle being a portion to be folded; and
a folding-transporter that transports the sheet bundle in such a manner as to pinch and fold the sheet bundle having the portion pressed and bent by the press-bender as a leading end, and
the folding-transporter temporarily stops transporting the sheet bundle in accordance with a position of the binding unit.

3. The sheet processing apparatus according to claim 1, wherein the stapleless binding device is disposed to be movable between a binding position and a retreating position, the binding position being a position at which the stapleless binding device approaches the sheet bundle to perform binding processing, the retreating position being a position to which the stapleless binding device retreats from the sheet bundle, and the stapleless binding device moves from the retreating position to the binding position when performing the binding processing.

4. The sheet processing apparatus according to claim 2, wherein the position of the sheet bundle to be bound by the stapleless binding device is controlled in accordance with a transport amount of the folding-transporter, the transport amount being an amount by which the folding-transporter transports the sheet bundle before the folding-transporter temporarily stops transporting the sheet bundle.

5. The sheet processing apparatus according to claim 2, wherein:
the binding unit of the stapleless binding device is a pressure-binding unit that binds the sheet bundle at the position of the portion near the fold line by applying pressure to the portion near the fold line; and
the pressure-binding unit is disposed within a range from a feeding position of the folding-transporter to a position separated from the feeding position by half a length of a smallest one of the plurality of sheets formed into the sheet bundle, the feeding position of the folding-transporter being a position from which the sheet bundle is transported, the length of the smallest one of the plurality of sheets being the length of the smallest sheet when the sheets are being transported.

6. The sheet processing apparatus according to claim 3, further comprising:
a loader that loads the sheet bundle which has passed through the folding device, the sheet bundle being supplied to the loader in a state in which the fold line is the leading end; and
a passage that allows the sheet bundle to pass through the passage from the folding device to the loader,
wherein the binding position is set within the passage and the retreating position is set outside the passage.

7. The sheet processing apparatus according to claim 1, wherein the stapleless binding device performs binding processing in such a manner that, as the number of the sheets to be formed into the sheet bundle becomes greater, the number of portions to be bound in a direction along the fold line of the sheet bundle becomes greater.

8. The sheet processing apparatus according to claim 7, wherein, when the number of the sheets to be formed into the sheet bundle is two, the number of portions to be bound is two, and, as the number of the sheets to be formed into the sheet bundle is increased by one, the number of portions to be bound is increased by one.

9. The sheet processing apparatus according to claim 1, further comprising:
a staple binding device that binds the sheet bundle with a staple before the folding device folds the sheet bundle; and
a selector that selects whether to perform stapleless binding processing using the stapleless binding device or staple binding processing using the staple binding device as binding processing for the sheet bundle.

10. An image forming system comprising:
an image forming apparatus that forms an image on a sheet; and
a sheet processing apparatus that performs binding processing for a sheet bundle which is formed by stacking a plurality of sheets supplied from the image forming apparatus,
wherein the sheet processing apparatus is the sheet processing apparatus according to claim 1.

11. An image forming system comprising:
an image forming apparatus that forms an image on a sheet; and
a sheet processing apparatus that performs binding processing for a sheet bundle which is formed by stacking a plurality of sheets supplied from the image forming apparatus,
wherein the sheet processing apparatus is the sheet processing apparatus according to claim 2.

12. An image forming system comprising:
an image forming apparatus that forms an image on a sheet; and
a sheet processing apparatus that performs binding processing for a sheet bundle which is formed by stacking a plurality of sheets supplied from the image forming apparatus,
wherein the sheet processing apparatus is the sheet processing apparatus according to claim 3.

13. An image forming system comprising:
an image forming apparatus that forms an image on a sheet; and
a sheet processing apparatus that performs binding processing for a sheet bundle which is formed by stacking a plurality of sheets supplied from the image forming apparatus,
wherein the sheet processing apparatus is the sheet processing apparatus according to claim 4.

14. An image forming system comprising:
an image forming apparatus that forms an image on a sheet; and
a sheet processing apparatus that performs binding processing for a sheet bundle which is formed by stacking a plurality of sheets supplied from the image forming apparatus,
wherein the sheet processing apparatus is the sheet processing apparatus according to claim 5.

15. An image forming system comprising:
an image forming apparatus that forms an image on a sheet; and
a sheet processing apparatus that performs binding processing for a sheet bundle which is formed by stacking a plurality of sheets supplied from the image forming apparatus,
wherein the sheet processing apparatus is the sheet processing apparatus according to claim 6.

16. An image forming system comprising:
an image forming apparatus that forms an image on a sheet; and
a sheet processing apparatus that performs binding processing for a sheet bundle which is formed by stacking a plurality of sheets supplied from the image forming apparatus,
wherein the sheet processing apparatus is the sheet processing apparatus according to claim 7.

17. An image forming system comprising:
an image forming apparatus that forms an image on a sheet; and
a sheet processing apparatus that performs binding processing for a sheet bundle which is formed by stacking a plurality of sheets supplied from the image forming apparatus,
wherein the sheet processing apparatus is the sheet processing apparatus according to claim 8.

18. An image forming system comprising:
an image forming apparatus that forms an image on a sheet; and
a sheet processing apparatus that performs binding processing for a sheet bundle which is formed by stacking a plurality of sheets supplied from the image forming apparatus,
wherein the sheet processing apparatus is the sheet processing apparatus according to claim 9.

19. A sheet processing apparatus comprising:
folding means for folding a sheet bundle which is formed of a plurality of sheets stacked on each other; and
stapleless binding means including a binding unit for binding the sheet bundle at a position of a portion near a fold line without using a staple, the fold line being formed as a result of the folding means folding the sheet bundle.
